(19) United States
(12) Patent Application Publication
(10) Pub. No.: US 2004/0053134 A1
(43) Pub. Date: Mar. 18, 2004

(54) Non-aqueous electrolyte secondary battery and method for producing active material substance used for anode thereof

(76) Inventors: Yoshiyuki Ozaki, Wakayama (JP); Keisuke Omori, Wakayama (JP); Tetsushi Kajikawa, Shizuoka (JP)

Correspondence Address: MERCHANT & GOULD PC, P.O. BOX 2903, MINNEAPOLIS, MN, 55402-0903, US

(21) Appl. No.: 10/466,446

(22) PCT Filed: Jan. 15, 2002
(86) PCT No.: PCT/JP02/00212

(30) Foreign Application Priority Data
Jan. 16, 2001 (JP) 2001007344
Oct. 25, 1991 (JP) 2001327358

(51) Int. Cl. H01M 4/52; C01G 51/04; C01G 53/04

(52) U.S. Cl. 429/231.1; 423/593.1; 429/231.3; 429/223; 423/594.4; 423/594.6

(57) ABSTRACT

A non-aqueous electrolyte secondary battery comprising an anode (12) capable of reversible occlusion and release of lithium ions, and a cathode (13) also capable of reversible occlusion and release of lithium ions, the anode (12) containing as an active substance a complex oxide containing lithium. An anode active substance in a fully charged state has a maximum heating peak of at least 270° C. at differential scanning calorie measuring. The secondary battery can restricts thermal runaway even in an abnormal status and is high in safety. A production method for an active substance suitably used for the anode of the non-aqueous electrolyte is provided.

### TECHNICAL FIELD

The present invention relates to a nonaqueous electrolyte secondary battery and a method for producing an active material used for the positive electrode thereof.

### BACKGROUND ART

Nonaqueous electrolyte secondary batteries have a high voltage and energy density and are used widely as a power source for consumer electronic equipment. Furthermore, in recent years, large scale batteries to be used in electric cars or storage of nighttime power have been under in-depth development, and there is a demand for economical secondary batteries having a higher capacity and energy density.

In the nonaqueous electrolyte secondary batteries, thermal runaway may occur in an abnormal state. The thermal runaway is caused primarily by an abnormal state that raises the temperature inside the battery so that the balance between the amount of generated heat and the amount of released heat is broken. In other words, in the case of an abnormal state such as short-circuit, a large current flows between the positive electrode and the negative electrode so that heat is generated in a short time, and therefore the heat release cannot keep up with the heat generation. As a result, the battery temperature increases and a spontaneous chemical reaction occurs in the positive and negative electrodes, which may lead to thermal runaway. In particular, when an increase of the battery temperature causes thermal decomposition of the active material of the positive electrode, the thermal runaway of the battery is promoted by the release of oxygen due to the decomposition.

Therefore, in the nonaqueous electrolyte secondary batteries, various measures are being considered in order to improve the safety of the batteries. For example, a flame-resistant electrolyte is under consideration. A separator (porous film) that stops a battery reaction during heat generation with micropores that are closed by heat generation to prevent lithium ions from passing through the micropores also is under consideration. Furthermore, a structure that releases gas and electrolyte from the battery to the outside when the internal pressure of the battery is increasing in order to suppress the thermal runaway to a minimal level also is under consideration.

The present invention is carried out in view of the above situations and has an object of providing a secondary battery that can suppress thermal runaway even in an abnormal state. The present invention has another object of providing a method for producing a composite oxide that can be used as an active material for the positive electrode of such a secondary battery.

### DISCLOSURE OF INVENTION

In order to achieve the above object, a first nonaqueous electrolyte secondary battery of the present invention includes a positive electrode that can absorb and release lithium ions reversibly, and a negative electrode that can absorb and release lithium ions reversibly. The positive electrode contains a composite oxide containing lithium as an active material, and the active material in a fully charged state has a largest heat generation peak at 270° C. or more in differential scanning calorimetry. According to this nonaqueous electrolyte secondary battery, thermal runaway can be suppressed in an abnormal state. In this specification, a “fully charged state” refers to a state in which a battery is fully charged based on the designed capacity of the battery. In this specification, a “heat generation peak in differential scanning calorimetry” means a peak when the results of differential scanning calorimetry are plotted with the temperature in the horizontal axis and the amount of generated heat in the vertical axis.

Furthermore, a second nonaqueous electrolyte secondary battery of the present invention includes a positive electrode that can absorb and release lithium ions reversibly, and a negative electrode that can absorb and release lithium ions reversibly. The positive electrode contains an active material that is expressed by a general formula

LiₓNi_{1-(y+z)}Co_{y}M_{z}O₂ (where 0<x≦1.05, 0.1≦y≦0.35 and 0.03≦z≦0.20, and M is at least one element selected from the group consisting of Al, Ti, Mn, Mg, Sn and Cr), and the active material that satisfies x≦0.35 has a heat generation peak at 270° C. or more and 350° C. or less in differential scanning calorimetry. According to this nonaqueous electrolyte secondary battery, thermal runaway can be suppressed in an abnormal state.

In the second nonaqueous electrolyte secondary battery, it is preferable that the element M is Al.

Furthermore, a method for producing an active material to be used for the positive electrode of a nonaqueous electrolyte secondary battery includes:

(i) neutralizing an aqueous solution in which a plurality of metal salts are dissolved so as to precipitate a composite hydroxide of the plurality of metals; and

(ii) mixing a lithium compound with the composite hydroxide to prepare a mixture and firing the mixture. By using the active material produced by this method, a secondary battery in which thermal runaway can be suppressed in an abnormal state can be produced.

In the above method, it is preferable that the salts include a nickel salt, a cobalt salt, and a salt of at least one element selected from the group consisting of Al, Ti, Mn, Mg, Sn and Cr.

In the above method, it is preferable that the nickel salt, the cobalt salt and the salt of the element M are dissolved in the aqueous solution such that the value of (the number of the atoms of the element M)/(the number of nickel atoms+the number of cobalt atoms+the number of the atoms of the element M) is 0.03 or more and 0.20 or less, and the value of (the number of cobalt atoms)/(the number of nickel atoms+the number of cobalt atoms+the number of the atoms of the element M) is 0.1 or more and 0.35 or less.

In the above method, it is preferable that the element M is Al.

### BRIEF DESCRIPTION OF DRAWINGS

FIG. 1 is a partially exploded perspective view showing an example of a nonaqueous electrolyte secondary battery of the present invention.

FIG. 2 is a view showing an example of heat generation peaks in differential scanning calorimetry with respect to the active materials produced by the production method of the present invention and the active materials of comparative examples.

FIG. 3 is a view showing another example of heat generation peaks in differential scanning calorimetry with respect to the active materials produced by the production method of the present invention and the active materials of comparative examples.

### BEST MODE FOR CARRYING OUT THE INVENTION

Hereinafter, embodiments of the present invention will be described.

### Embodiment 1

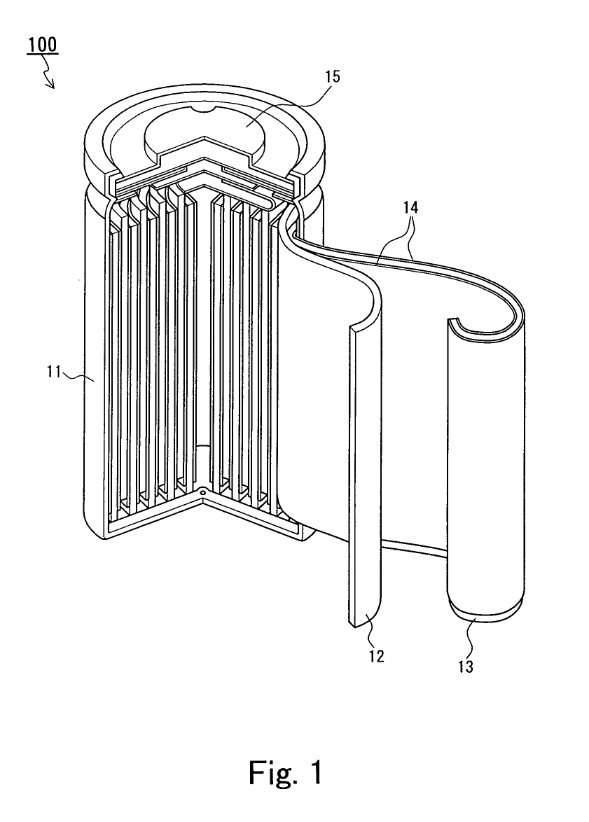

In Embodiment 1, a nonaqueous electrolyte secondary battery of the present invention will be described. FIG. 1 shows a partially exploded perspective view of a cylindrical secondary battery 100 as an example of the secondary battery of Embodiment 1.

Referring to FIG. 1, the secondary battery 100 includes a case 11, a positive electrode 12, a negative electrode 13, a separator 14, and a nonaqueous electrolyte (not shown) that are enclosed in the case 11, and a sealing plate 15 provided with a safety valve. The separator 14 is disposed between the positive electrode 12 and the negative electrode 13. Each of the positive electrode 12 and the negative electrode 13 can absorb and release lithium ions reversibly.

The components except the positive electrode 12 can be formed of materials commonly used for a nonaqueous electrolyte secondary battery such as a lithium ion secondary battery. For example, for the negative electrode 13, a negative electrode including a metal support member and an active material for a negative electrode supported by the support member can be used. For the active material of the negative electrode 13, for example, a hardly graphitized carbon or graphite can be used.

For the separator 14, for example, a porous polyethylene film or a porous polypropylene film can be used.

For the nonaqueous electrolyte, an organic solvent in which a solute containing Li is dissolved can be used. Examples of the solute include LiPF₆, LiAsF₆, LiBF₄, LiClO₄, and LiCF₃SO₃. Among these, in view of the characteristics of the secondary battery, LiPF₆ and LiCF₃SO₄ are particularly preferable. For the organic solvent, propylene carbonate (PC), ethylene carbonate (EC), dimethyl carbonate (DMC), ethyl methyl carbonate (EMC), diethyl carbonate (DEC), dimethoxy ethane (DME), vinylene carbonate (VC), γ-butyrolactone (GBL), tetrahydrofuran (THF), dioxolane (DOXL), 1,2-diethoxyethane (1,2-DEE), buthylene carbonate (BC), methyl propionate (MP), and ethyl propionate (EP) can be used. A combination of these organic solvents can be used, depending on the design of the battery.

The positive electrode 12 includes a metal support member and an active material supported by the support member. In the secondary battery of the present invention, a composite oxide containing lithium and another metal is used as the active material for the positive electrode. More specifically, an active material having a heat generation peak at 270° C. or more in differential scanning calorimetry when the battery is in a fully charged state can be used as the active material. Furthermore, an active material that is expressed by a general formula LiₓNi_{1-(y+z)}CO_{y}M_{z}O₂ (where 0<x≦1.05, 0.1≦y≦0.35 and 0.03≦z≦0.20, and M is at least one element selected from the group consisting of Al, Ti, Mn, Mg, Sn and Cr) and has a heat generation peak at 270° C. or more and 350° C. or less in differential scanning calorimetry when x≦0.35 is satisfied also can be used.

The inventors of the present invention caused an internal short-circuit on purpose in various battery systems, and then checked whether or not thermal runaway occurs and measured the temperature of the battery case. From the results, they found out that in some batteries employing active materials having specific properties, thermal runaway does not occur even if the battery is in a fully charged state.

Batteries in which thermal runaway occurred in the short-circuit test and batteries in which thermal runaway did not occur were fully charged, and then the batteries were disassembled, and the support member of the positive electrode was separated from a mixture containing an active material. The thus removed active material of the positive electrode was subjected to thermal analysis measurement using a differential scanning calorimeter (hereinafter, also referred to as DSC measurement). For the calorimeter, a meter (Thermo Plus DSC8230: manufactured by Rigaku Cooperation) having a measurable temperature range from −176° C. to 750° C. was used. About 5 mg of the removed active material of the positive electrode was put in a sample container (made of SUS, a withstand pressure: 50 atm) to be used as a sample for measurement. This sample was subjected to DSC measurement by increasing the temperature from room temperature to 400° C. at a rate of 10° C./min in a still air atmosphere. As a result, for the active material of a battery in which thermal runaway occurs, the largest heat generation peak attributed to the thermal decomposition thereof appeared at 200° C. to 250° C. On the other hand, for the active material of a battery in which thermal runaway does not occur, the largest heat generation peak appeared at 270° C. or more. Therefore, by selecting an active material having a heat generation peak attributed to thermal decomposition at 270° C. or more, high safety can be ensured, even if the battery temperature is increased in an abnormal state.

These results can be obtained, possibly because the stability of the active material of the positive electrode with respect to heat is high. As described above, the principal cause of the thermal runaway due to short-circuit is the decomposition of the positive electrode and the negative electrode. In particular, the positive electrode is thermally decomposed by an increase of the temperature and promotes the thermal runaway. However, if the thermal stability of the active material of the positive electrode is ensured sufficiently with respect to the temperature increase due to an instantaneous short-circuit current, the thermal decomposition, which promotes thermal runaway, can be suppressed.

As the active material of the positive electrode, various materials including LiCoO₂, LiNiO₂ and LiMn₂O₄ can be used. LiCoO₂ provides a battery having a high voltage and energy density, and has an advantage in that the stability and the cycle lifetime characteristics are excellent at a high temperature. However, cobalt is a rare resource and is produced only in a limited district, and therefore cobalt is expensive and unstable in the supply. LiMn₂O₄ is excellent in the safety but inferior to LiCoO₂ in the cycle lifetime characteristics and the high stability. For this reason, it is attempted to substitute part of manganese atoms with another transition metal element such as cobalt, chromium or nickel, but sufficient improvement has not been achieved. LiNiO₂ is a material for a positive electrode having a high capacity density, but the crystal structure varies with charging and discharging, and therefore the reversibility of a reaction is poor. For this reason, it is common that LiNiO₂ is used in the form of a composite oxide in which part of an element Ni is substituted with another element such as Co. Among these, composite oxides containing lithium and nickel are inexpensive and have excellent cycle lifetime characteristics and high temperature stability, and therefore are suitable as the active material of the positive electrode of a large battery.

More specifically, it is preferable to use an active material that is expressed by a general formula LiₓNi_{1-(y+z)}Co_{y}M_{z}O₂ and has a largest heat generation peak in the range from 270° C. to 350° C. in differential scanning calorimetry when x≦0.35 is satisfied, where 0<x≦1.05, 0.1≦y≦0.35 and 0.03≦z≦0.20, and M is at least one element selected from the group consisting of Al, Ti, Mn, Mg, Sn and Cr. The value of x indicating the content of Li varies with the charging state. This active material can be produced by the method described in Embodiment 2. It is more preferable that the element M is Al and that 0.15≦y≦0.25 and 0.10≦z≦0.20.

### Embodiment 2

In Embodiment 2, a method for producing an active material (composite oxide) of the present invention will be described. This active material is used for the positive electrode of a nonaqueous electrolyte secondary battery.

In the production method of Embodiment 2, first, an aqueous solution in which a plurality of metal salts are dissolved is neutralized so that a composite hydroxide of the plurality of metals is precipitated (step (i)).

It is preferable that the salts dissolved in an aqueous solution contain a Ni salt, a Co salt, and a salt of at least one element M selected from the group consisting of Al, Ti, Mn, Mg, Sn and Cr. In particular, it is preferable that the salts dissolved in an aqueous solution are a Ni salt, a Co salt, and an Al salt. The neutralization of the aqueous solution can be performed by dripping sodium hydroxide while stirring the aqueous solution.

As the Ni salt, for example, sulfates or nitrates can be used. As the Co salt, for example, sulfates or nitrates can be used. As the Al salt, for example, sulfates can be used. The element ratio in a composite oxide that can be formed in a subsequent step can be varied by varying the concentration of these salts. It is preferable that the active material produced in Embodiment 2 is a composite oxide expressed by a general formula LiₓNi_{1-(y+z)}Co_{y}M_{z}O₂, (where 0<x≦1.05, 0.1≦y≦0.35 and 0.03≦z≦0.20, and M is at least one element selected from the group consisting of Al, Ti, Mn, Mg, Sn and Cr). For this, it is preferable that the nickel salt, the cobalt salt and the salt of M are dissolved in an aqueous solution such that the value of (the number of the atoms of the element M)/(the number of nickel atoms+the number of cobalt atoms+the number of the atoms of the element M) is 0.03 or more and 0.20 or less. Furthermore, it is preferable that the nickel salt, the cobalt salt and the salt of M are dissolved in an aqueous solution such that the value of (the number of cobalt atoms)/(the number of nickel atoms+the number of cobalt atoms+the number of the atoms of the element M) is 0.1 or more and 0.35 or less.

Then, a lithium compound is mixed with the composite hydroxide obtained in the step (i) and the mixture is fired, and thus a composite oxide containing the metals contained in the composite hydroxide and lithium can be formed (step (ii)). There is no particular limitation regarding the condition of the firing, but for example, heating can be performed at a temperature of about 750° C. to 850° C. for about 10 hours to 20 hours. As a lithium compound, for example, lithium hydroxide or lithium carbonate can be used.

According to the method of Embodiment 2, an active material satisfying the following conditions can be produced:

(1) being expressed by a general formula LiₓNi_{1-(y+z)}Co_{y}M_{z}O₂, (where 0<x≦1.05, 0.1≦y≦0.35 and 0.03≦z≦0.20, and M is at least one element selected from the group consisting of Al, Ti, Mn, Mg, Sn and Cr); and

(2) having a largest heat generation peak at 270° C. or more and 350° C. or less in differential scanning calorimetry when x≦0.35 is satisfied. Thus, by the production method of Embodiment 2, the active material described in Embodiment 1 can be produced.

### EXAMPLES

Hereinafter, examples of the present invention will be described. In the following examples, DSC measurement was performed using the meter and the method described in Embodiment 1.

### Example 1

In Example 1, six lithium secondary batteries having different active materials for the positive electrodes were produced and the characteristics thereof were evaluated. Batteries 1 to 6 were produced such that they had the same diameter of the electrode plate group and the same capacity density of the negative electrode.

(Battery 1)

For the active material of the positive electrode of a battery 1, lithium nickelate (LiNiO₂) produced in the following manner was used. First, lithium hydroxide (LiOH) and nickel hydroxide were mixed such that the atomic ratio of lithium and nickel was 1.0:1.0. This mixture was heated to 500° C. at a temperature increase rate of 5° C./min in an oxygen atmosphere, and fired at 500° C. for seven hours (first firing). The thus obtained product was cooled to 100° C. or less, and pulverized to powder with a grinding pulverizer. The average particle diameter of the obtained powder was 15 μm, and the content rate of particles having a particle diameter of 40 μm or more was 0.07 weight %. Then, the powder was heated to 800° C. at a temperature increase rate of 5° C./min in an oxygen atmosphere, and fired at 800° C. for 15 hours (second firing). The thus obtained product was cooled to 100° C. or less, and pulverized to powder with a grinding pulverizer. The obtained compound was used as the active material of the positive electrode.

The capacity density of the negative electrode was 200 Ah/kg in view of the capacity balance of the positive electrode and the negative electrode. The thickness and the length of the positive electrode plate and the negative electrode plate were designed such that the diameter of the electrode plate group was 60 mm.

The positive electrode plate was produced in the following manner. First, 4 parts by weight of polyvinylidene fluoride (PVdF) as a binding agent were dissolved in N-methyl pyrrolidone (NMP). To this NMP solution, 100 parts by weight of the active material for the positive electrode and 4 parts by weight of acetylene black (AB), which is a conductive material, were added, and the mixture was kneaded to be formed into a paste. This paste was applied onto both surfaces of an aluminum foil such that the width was 75 mm, and dried and rolled. Thus, a positive electrode plate having a thickness of 0.075 mm and a length of 9450 mm was obtained.

The negative electrode plate was produced in the following manner. For the active material of the negative electrode, hardly graphitized carbon having an average particle diameter of 7 μm was used. A NMP solution in which 9 parts by weight of PVdF were dissolved was added to 100 parts by weight of hardly graphitized carbon, and the mixture was kneaded to be formed into a paste. This paste was applied onto both surfaces of a copper foil such that the width was 80 mm, and dried and rolled. Thus, a negative electrode plate having a thickness of 0.150 mm and a length of 9710 mm was obtained.

These positive and negative electrode plates were curled in a coil form together with a separator made of porous polyethylene (a thickness of 0.027 mm, a width of 85 mm and a length of 10000 mm) interposed between the positive and negative electrode plates, and thus an electrode plate group was obtained. Then, this electrode plate group was accommodated in a battery case (a diameter of 62 mm and a height of 100 mm). Finally, an electrolyte was poured into the battery case, and then the case was sealed. Thus, a battery 1 was obtained. The electrolyte was obtained by dissolving 1.5 mol/l of lithium phosphate hexafluoride (LiPF₆) in a solvent in which ethylene carbonate (EC) and ethyl methyl carbonate (EMC) were mixed in a volume ratio of 20:80.

(Battery 2)

A battery 2 was produced in the following manner. First, lithium hydroxide, nickel hydroxide and aluminum hydroxide were mixed such that the atomic ratio of lithium, nickel and aluminum was 1.0:0.94:0.06, and firing was performed under the same conditions as in the case of the active material of the positive electrode of the battery 1. Thus, lithium nickelate (LiNi_{0.94}Al_{0.06}O₂) in which 6 atomic % of nickel was substituted with aluminum was produced and was used as the active material of the positive electrode. Using this active material, a positive electrode plate having a thickness of 0.075 mm and a length of 10400 mm was produced. Using this positive electrode plate, a negative electrode plate (10660 mm), a separator (11000 mm) and an electrolyte, a battery 2 was produced in the same manner as the battery 1. For the negative electrode plate, the separator and the electrolyte, the same ones as those used for the battery 1 were used.

(Battery 3)

A battery 3 was produced in the following manner. First, lithium hydroxide, nickel hydroxide and aluminum hydroxide were mixed such that the atomic ratio of lithium, nickel and aluminum was 1.0:0.92:0.08, and firing was performed under the same conditions as in the case of the active material of the positive electrode of the battery 1. Thus, lithium nickelate (LiNi_{0.92}Al_{0.08}O₂) in which 8 atomic % of nickel was substituted with aluminum was produced and was used as the active material of the positive electrode. Using this active material, a positive electrode plate having a thickness of 0.075 mm and a length of 10600 mm was produced. Using this positive electrode plate, a negative electrode plate (a length of 10860 mm), a separator (a length of 11150 mm) and an electrolyte, a battery 3 was produced in the same manner as the battery 1. For the negative electrode plate, the separator and the electrolyte, the same ones as those used for the battery 1 were used.

(Battery 4)

A battery 4 was produced in the following manner. First, lithium hydroxide, nickel hydroxide and aluminum hydroxide were mixed such that the atomic ratio of lithium, nickel and aluminum was 1.0:0.9:0.1, and firing was performed under the same conditions as in the case of the active material of the positive electrode of the battery 1. Thus, lithium nickelate (LiNi_{0.9}Al_{0.1}O₂) in which 10 atomic % of nickel was substituted with aluminum was produced and was used as the active material of the positive electrode. Using this active material, a positive electrode plate having a thickness of 0.075 mm and a length of 10900 mm was produced. Using this positive electrode plate, a negative electrode plate (a length of 11160 mm), a separator (a length of 11500 mm) and an electrolyte, a battery 4 was produced in the same manner as the battery 1. For the negative electrode plate, the separator and the electrolyte, the same ones as those used for the battery 1 were used.

(Battery 5)

A battery 5 was produced in the following manner. First, lithium carbonate (Li₂CO₃) and manganese dioxide (MnO₂) were mixed such that the atomic ratio of Li and Mn was 1:2 to prepare a mixture. This mixture was fired at 850° C. for 30 hours, and thus lithium manganate (LiMn₂O₄) was obtained. The lithium manganate was classified to provide lithium manganate powder having an average particle diameter of 5 μm, and this powder was used as the active material of the positive electrode. Using this active material, a positive electrode plate having a thickness of 0.075 mm and a length of 12700 mm was produced. Using this positive electrode plate, a negative electrode plate (a length of 12960 mm), a separator (a length of 13500 mm) and an electrolyte, a battery 5 was produced in the same manner as the battery 1. For the negative electrode plate, the separator and the electrolyte, the same ones as those used for the battery 1 were used.

(Battery 6)

A battery 6 was produced in the following manner. First, lithium carbonate (Li₂CO₃) and tricobalt tetroxide (Co₃O₄) were mixed such that the atomic ratio of Li and Co was 1:1 to prepare a mixture, and this mixture was fired at 900° C. for 10 hours, and thus lithium cobaltate (LiCoO₂) was obtained. The lithium cobaltate was classified to provide lithium cobaltate powder having an average particle diameter of 7 μm, and this powder was used as the active material of the positive electrode. Using this active material, a positive electrode plate having a thickness of 0.075 mm and a length of 11300 mm was produced. Using this positive electrode plate, a negative electrode plate (a length of 11560 mm), a separator (a length of 11900 mm) and an electrolyte, a battery 6 was produced in the same manner as the battery 1. For the negative electrode plate, the separator and the electrolyte, the same ones as those used for the battery 1 were used.

The thus obtained batteries 1 to 6 were charged until the battery voltage reached 4.3 V and were discharged until the battery voltage reached 2.5 V. This operation of charging and discharging was repeated 10 times. Thereafter, the batteries were charged until the battery voltage reached 4.4 V, and then the batteries were stored for 5 hours.

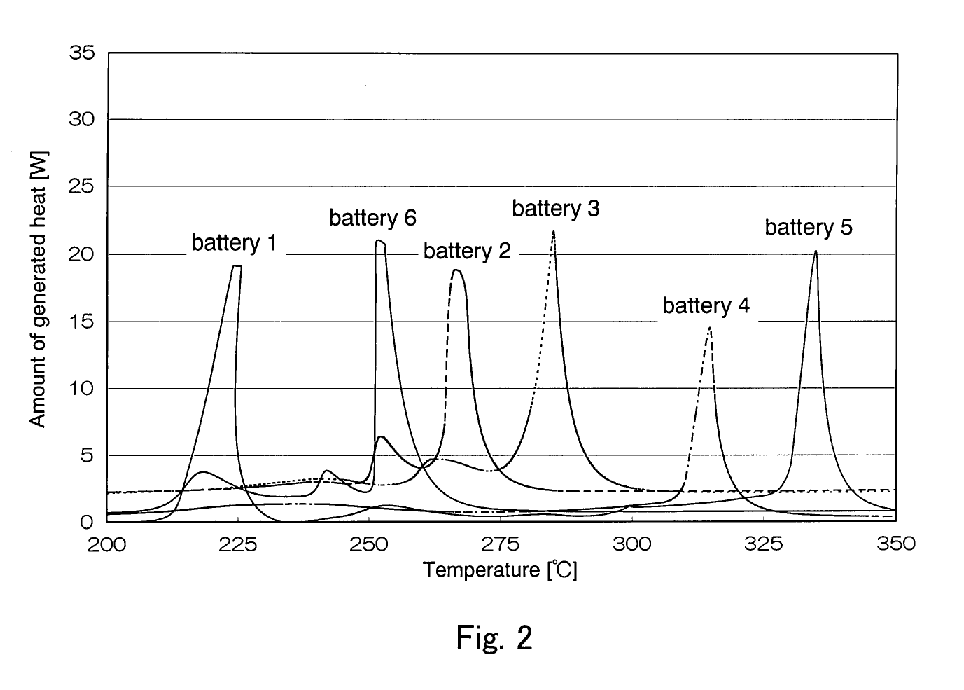

The mixtures of the positive electrodes of batteries 1 to 6 that had been stored were taken out and subjected to the DSC measurement. A nail stick test and a crushing test with a round rod were performed. FIG. 2 shows the results of the DSC measurement.

As seen from FIG. 2, the largest heat generation peaks of the batteries 1 to 6 were at 220° C., 270° C., 285° C., 315° C., 335° C. and 250° C., respectively. These heat generation peaks are all attributed to the decomposition reaction of the active materials of the positive electrodes.

Next, the nail stick test and the crushing test will be described. The nail stick test was performed by sticking a nail having a diameter of 3 mm into each battery at a rate of 1 cm/second. As a result, in the batteries 1 and 6, thermal runaway occurred instantly. On the other hand, in the batteries 2, 3, 4, and 5, thermal runaway did not occur. In the crushing test with a round bar, the batteries were crushed to ¼ of the original diameter with a round rod having a diameter of 6 mm. As a result, as in the nail stick test, in the batteries 1 and 6, thermal runaway occurred instantly. On the other hand, in the batteries 2, 3, 4, and 5, thermal runaway did not occur.

Table 1 shows the discharge capacity of each battery in the 10^{th} operation of charging and discharging, the position of the largest heat generation peak in the DSC measurement, the results of the nail stick test and the results of the crushing test.

TABLE 1

| | | heat | | |
|---|---|---|---|---|
| | | generation | | |
| | | peak | | |
| | capacity | position | | |
| | [Ah] | [° C.] | nail stick test | crushing test |
| battery 1 | 17.5 | 220 | thermal runaway | thermal runaway |
| | | | occurred | occurred |
| battery 2 | 15.5 | 270 | no thermal | no thermal runaway |
| | | | runaway | |
| battery 3 | 15.3 | 285 | no thermal | no thermal runaway |
| | | | runaway | |
| battery 4 | 14.5 | 315 | no thermal | no thermal runaway |
| | | | runaway | |
| battery 5 | 11.3 | 335 | no thermal | no thermal runaway |
| | | | runaway | |
| battery 6 | 14.0 | 250 | thermal runaway | thermal runaway |
| | | | occurred | occurred |

As seen from Table 1, the battery in which thermal runaway does not occur in the nail stick test or the crushing test can be obtained by using the active material for the positive electrode having a largest heat generation peak at 270° C. or more in the DSC measurement.

### Example 2

In Example 2, three lithium secondary batteries made of different active materials for the positive electrodes were produced and the characteristics thereof were evaluated. The following batteries were designed such that the capacity density of the negative electrode was in the range from 230 Ah/kg to 250 Ah/kg. Furthermore, the thickness of the negative electrode plate and the lengths of the positive and negative electrode plates were adjusted, depending on the capacity density of the positive electrode.

(Battery 7)

For the active material of the positive electrode of a battery 7, a composite oxide expressed by a composition formula LiNi_{0.7}Co_{0.2}Al_{0.1}O₂ produced in the following manner was used. First, lithium hydroxide (LiOH.H₂O), nickel hydroxide (Ni(OH)₂), tricobalt tetroxide (Co₃O₄), aluminum hydroxide (Al(OH)₃) were mixed such that the atomic ratio of lithium, nickel, cobalt and aluminum was 1.0:0.7:0.2:0.1. Then, this mixture was fired at 800° C. for 15 hours in an oxygen atmosphere. The thus obtained composite oxide (LiNi_{0.7}Co_{0.2}Al_{0.1}O₂) was pulverized and then classified to provide an active material powder having an average particle diameter of 10 μm. Powder X-ray diffraction confirmed that this active material (composite oxide) had a single phase hexagonal layered structure and that cobalt and aluminum formed solid solutions.

Then, 3 parts by weight of AB were added to 100 parts by weight of the above active material to prepare a mixture. A solution in which PVdF was dissolved in NMP was added to this mixture, and the mixture was kneaded so as to be formed into a paste. The paste was prepared such that the amount of PVdF with respect to 100 parts by weight of the active material was 4 parts by weight. Then, this paste was applied onto both surfaces of an aluminum foil in a width of 75 mm, and dried, and then rolled. Thus, a positive electrode plate having a thickness of 0.075 mm and a length of 9450 mm was obtained.

For the active material of the negative electrode, hardly graphitized carbon powder obtained by thermally treating isotropic pitch was used. The spacing (d002) between the 002 planes of the hardly graphitized carbon was 0.380 nm. The average particle diameter of the powder was about 10 μm. The true density thereof was 1.54 g/cm³. A solution in which PVdF was dissolved in NMP was added to 100 parts by weight of the powder, and the mixture was kneaded to be formed into a paste. This paste was prepared such that the amount of PVdF with respect to 100 parts by weight of the carbon powder was 8 parts by weight. Then, this paste was applied onto both surfaces of a copper foil such that the width was 80 mm, and dried and rolled. Thus, a negative electrode plate having a thickness of 0.110 mm and a length of 9710 mm was obtained.

These positive and negative electrode plates were curled in coil form together with a separator interposed therebetween, and thus a coil-like electrode plate group was produced. For the separator, a microporous polyethylene film (a thickness of 0.027 mm, and a width of 85 mm) was used. Then, this electrode plate group was accommodated in a battery case (a diameter of 62 mm and a height of 100 mm), and an electrolyte was poured into the battery case, and then the case was sealed. The electrolyte was obtained by dissolving 1 mol/l of LiPF₆ in a solvent in which propylene carbonate (PC) and dimethyl carbonate (DMC) were mixed in a volume ratio of 1:1. Thus, a battery 7 was obtained.

(Battery 8)

A battery 8 was produced in the following manner. First, lithium hydroxide (LiOH.H₂O), nickel hydroxide (Ni(OH)₂), and tricobalt tetroxide (Co₃O₄) were mixed such that the atomic ratio of lithium, nickel, and cobalt was 1.0:0.8:0.2. Then, this mixture was fired at 800° C. for 15 hours in an oxygen atmosphere. The thus obtained composite oxide (LiNi_{0.8}Co_{0.2}O₂) was pulverized and then classified to provide an active material powder having an average particle diameter of about 10 μm. The battery 8 was produced with the same members in the same manner as the battery 7, except that this active material was used.

(Battery 9)

A battery 9 was produced in the following manner. For the active material for the positive electrode of the battery 9, LiNi_{0.7}Co_{0.2}Al_{0.1}O₂, which is the same composition of the active material for the positive electrode of the battery 7, was used. The active material for the positive electrode of the battery 9 was produced in the same manner as the battery 7, except that the firing conditions for the mixture of the materials was changed. More specifically, the active material for the positive electrode of the battery 9 was produced by firing the mixture of the materials in an oxygen atmosphere at 750° C. for 15 hours. Powder X-ray diffraction confirmed the completion of the synthesis reaction and the solid solutions of cobalt and aluminum. The battery 9 was produced with the same members in the same manner as the battery 7, except that the thus obtained active material was used.

Four cells of each of the batteries 7 to 9 were prepared, and were charged with a constant current (5 hour rate) until the battery voltage reached 4.2 V and was discharged until the battery voltage reached 2.5 V. This operation of charging and discharging was repeated 9 times. Then, after the 10^{th} operation of charging, the charged batteries were stored. From the calculations based on the charge and discharge capacity, in all the charged batteries, the amount of lithium of the active material of the positive electrode expressed by a general formula LiₓNi_{1-(y+z)}Co_{y}Al_{z}O₂ was x≦0.35.

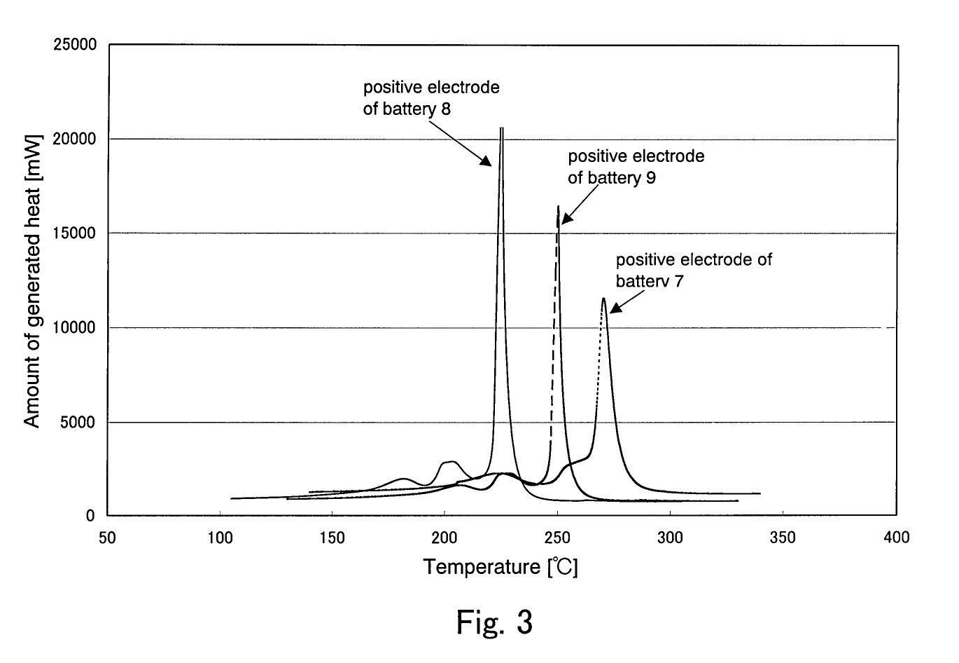

One of each of the charged batteries was disassembled in a dry air atmosphere and the mixture of the positive electrode was taken out. The mixture of the positive electrode was subjected to the DSC measurement. FIG. 3 shows the results of the DSC measurement of the batteries 7 to 9. The remaining batteries were subjected to the nail stick test. The nail stick test was performed by allowing an iron nail having a diameter of 3 mm to penetrate the substantially central portion of the battery at a rate of 1 cm/second.

Table 2 shows the discharge capacity in the 9^{th} cycle of each battery, the position of the largest heat generation peak in the DSC measurement, and the results of the nail stick test.

TABLE 2

| | capacity | heat generation | |
|---|---|---|---|
| | [Ah] | peak position [° C.] | nail stick test |
| battery 7 | 15.0 | 270 | no thermal runaway |
| battery 8 | 17.0 | 225 | thermal runaway occurred |
| battery 9 | 15.5 | 250 | thermal runaway occurred |

As seen from Table 2, in the battery 7 employing LiNi_{0.7}Co_{0.2}Al_{0.1}O₂ as the active material for the positive electrode, the thermal runaway in the nail stick test was avoided successfully. The temperature of the largest heat generation peak was 270° C. In the battery 8 employing an active material that provided the largest heat generation peak at a temperature of 225° C., thermal runaway occurred in the nail stick test. Even if the compositions of the active materials of the batteries 7 and 9 were the same, the temperatures of the largest heat generation peaks in the DSC measurement were varied because of different synthesis conditions. In the battery 9, unlike the battery 7, thermal runaway occurred in the nail stick test.

These results indicate that it is important to use a lithium-nickel composite oxide in which a solid solution of an element (e.g., aluminum) other than cobalt is formed as the active material for the positive electrode, and further the synthesis conditions also are important. The results also indicate that the temperature of the largest heat generation peak in the DSC measurement is the index indicating whether or not thermal runaway can be suppressed in the nail stick test.

### Example 3

In Example 3, five lithium secondary batteries made of different active materials for the positive electrodes were produced and the characteristics thereof were evaluated.

(Battery 10)

For the active material for the positive electrode of a battery 10, a composite oxide (LiNi_{0.7}Co_{0.2}Al_{0.1}O₂) produced in the following manner was used. First, a sulfate of Co and a sulfate of Al were added to a NiSO₄ aqueous solution in a predetermined ratio to prepare a saturated aqueous solution of salts of Ni, Co and Al. This saturated aqueous solution was neutralized by dripping slowly an alkali solution in which sodium hydroxide was dissolved while stirring the saturated aqueous solution. With this operation, a precipitate of Ni_{0.7}Co_{0.2}Al_{0.1}(OH)₂ was produced by coprecipitation. The thus obtained composite hydroxide was filtered, washed and dried. Then, lithium hydroxide was added to the composite hydroxide such that the sum of the numbers of Ni, Co and Al atoms is substantially equal to the number of Li atoms. This mixture was fired in a dry air atmosphere at 750° C. for 10 hours, so that LiNi_{0.7}Co_{0.2}Al_{0.1}O₂ was obtained. Hereinafter, the method for producing the active material of the battery 10 may be referred to as “coprecipitation method”.

Powder X-ray diffraction confirmed that the thus obtained composite oxide had a single phase hexagonal layered structure. This composite oxide was pulverized and classified so that an active material powder having an average particle diameter of 10 μm was obtained for the positive electrode. The battery 10 was produced with the same member in the same manner as the battery 7, except that this active material was used.

(Battery 11)

A battery 11 was produced with an active material for a positive electrode having a different composition from that of the battery 10. More specifically, LiNi_{0.7}Co_{0.2}Al_{0.03}O₂ in which 20 atomic % of nickel was substituted with cobalt and 3 atomic % of nickel was substituted with aluminum was used as the active material for the positive electrode. The composition ratio in the active material was changed by changing the concentration of the salts in the aqueous solution (this applies to the following batteries). The battery 11 was produced with the same member in the same manner as the battery 10, except that this active material was used.

(Battery 12)

A battery 12 was produced with an active material for a positive electrode having a different composition from that of the battery 10. More specifically, LiNi_{0.6}Co_{0.2}Al_{0.2}O₂ in which 20 atomic % of nickel was substituted with cobalt and 20 atomic % of nickel was substituted with aluminum was used as the active material for the positive electrode. The battery 12 was produced with the same member in the same manner as the battery 10, except that this active material was used.

(Battery 13)

A battery 13 was produced with an active material for a positive electrode having a different composition from that of the battery 10. More specifically, LiNi_{0.8}Co_{0.2}O₂ in which aluminum was not dissolved and only cobalt was dissolved as a solid solution by the coprecipitation method was used as the active material for the positive electrode. The battery 13 was produced with the same member in the same manner as the battery 10, except that this active material was used.

(Battery 14)

A battery 14 was produced with an active material for a positive electrode having a different composition from that of the battery 10. More specifically, LiNi_{0.55}Co_{0.20}Al_{0.25}O₂ in which 20 atomic % of nickel was substituted with cobalt and 25 atomic % of nickel was substituted with aluminum was used as the active material for the positive electrode. The battery 14 was produced with the same member in the same manner as the battery 10, except that this active material was used.

The thus obtained five types of batteries were subjected to the same test as in Example 2. Table 3 shows the discharge capacity in the 9^{th} cycle of each battery, the temperature of the largest heat generation peak in the DSC measurement, and the results of the nail stick test.

TABLE 3

| | | heat | |
|---|---|---|---|
| | | generation | |
| | capacity | peak position | |
| | [Ah] | [° C.] | nail stick test |
| battery 10 | 15.5 | 310 | no thermal runaway |
| battery 11 | 16.0 | 272 | no thermal runaway |
| battery 12 | 14.9 | 315 | no thermal runaway |
| battery 13 | 17.0 | 230 | thermal runaway occurred |
| battery 14 | 13.0 | 355 | no thermal runaway |

From the results of Table 3, when a composite oxide expressed by a general formula LiₓNi_{1-(y+z)}Co_{y}Al_{z}O₂ produced with the coprecipitation method was used, if 3 atomic % or more of nickel was substituted with aluminum, the temperature of the largest heat generation peak in the DSC measurement was 270° C. or more, and thermal runaway was suppressed. When comparing the battery 7 with the battery 10, although the compositions of the active materials of the positive electrodes were the same, the largest heat generation peak in the DSC measurement of the battery 10 produced with the active material produced by the coprecipitation was higher. Moreover, the battery 10 had a higher thermal stability than that of the battery 7. On the other hand, the largest heat generation peak in the DSC measurement of the battery 14 in which 25 atomic % of nickel is substituted with aluminum was more than 350° C. In the battery 14, thermal runaway hardly occurred, but the capacity reduction was significant.

In the examples, hardly graphitized carbon was used for the active material for the negative electrode, but also when graphite having high crystallinity is used, substantially the same effect can be obtained. The battery employing hardly graphitized carbon is different from the battery employing graphite in the charge and discharge characteristics, and therefore it is preferable to select a negative material depending on the use of the battery.

Furthermore, cylindrical batteries have been described in the examples. However, the battery of the present invention can be applied to other batteries having various shapes. For example, even if the present invention is applied to a rectangular battery in which electrodes are curled in an elliptical form and accommodated in a rectangular case, or a rectangular battery in which a plurality of electrode plates are laminated and accommodated in a rectangular case, the same effect can be obtained. The present invention can be applied to batteries having various sizes. For example, the present invention can be applied to large batteries (e.g., 15 Ah class) used for electric power storage, electric cars or hybrid electric cars. Furthermore, even if the present invention is applied to high power batteries used for power tools or small batteries for consumer use, substantially the same effect can be obtained.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### Industrial Applicability

As described above, according to the nonaqueous electrolyte secondary battery of the present invention, thermal runaway can be prevented in an abnormal state, and a secondary battery having high safety can be obtained. Furthermore, according to the production method of the present invention, an active material that can be used for the positive electrode of the nonaqueous electrolyte secondary battery of the present invention can be produced.

1. A nonaqueous electrolyte secondary battery comprising a positive electrode that can absorb and release lithium ions reversibly, and a negative electrode that can absorb and release lithium ions reversibly,
wherein the positive electrode contains a composite oxide containing lithium as an active material, and
the active material in a fully charged state has a largest heat generation peak at 270° C. or more in differential scanning calorimetry.

2. A nonaqueous electrolyte secondary battery comprising a positive electrode that can absorb and release lithium ions reversibly, and a negative electrode that can absorb and release lithium ions reversibly,
wherein the positive electrode contains an active material that is expressed by a general formula LiₓNi_{1-(y+z)}Co_{y}M_{z}O₂ (where 0<x≦1.05, 0.1≦y≦0.35 and 0.03≦z≦0.20, and M is at least one element selected from the group consisting of Al, Ti, Mn, Mg, Sn and Cr), and
the active material that satisfies x≦0.35 has a largest heat generation peak at 270° C. or more and 350° C. or less in differential scanning calorimetry.

3. The nonaqueous electrolyte secondary battery according to claim 2, wherein the element M is Al.

4. A method for producing an active material to be used for a positive electrode of a nonaqueous electrolyte secondary battery comprising:
(i) neutralizing an aqueous solution in which a plurality of metal salts are dissolved so as to precipitate a composite hydroxide of the plurality of metals; and
(ii) mixing a lithium compound with the composite hydroxide to prepare a mixture and firing the mixture.

5. The method for producing an active material according to claim 4,
wherein the salts include a nickel salt, a cobalt salt, and a salt of at least one element selected from the group consisting of Al, Ti, Mn, Mg, Sn and Cr.

6. The method for producing an active material according to claim 5,
wherein the nickel salt, the cobalt salt and the salt of the element M are dissolved in the aqueous solution such that a value of (the number of the atoms of the element M)/(the number of nickel atoms+the number of cobalt atoms+the number of the atoms of the element M) is 0.03 or more and 0.20 or less, and a value of (the number of cobalt atoms)/(the number of nickel atoms+the number of cobalt atoms+the number of the atoms of the element M) is 0.1 or more and 0.35 or less.

7. The method for producing an active material according to claim 5,
wherein the element M is Al.
